(19) United States
(12) Patent Application Publication
(10) Pub. No.: US 2012/0230683 A1
(43) Pub. Date: Sep. 13, 2012

(54) System and Method for Remotely Monitoring Communication Equipment and Signals

(76) Inventors: Constantin Lacatus, Hamilton (CA); Andre Van Kesteren, Oakville (CA); Dan Baldor, Toronto (CA); Eric Fankhauser, Burlington (CA)

(21) Appl. No.: 11/738,977

(22) Filed: Apr. 23, 2007

(51) Int. Cl. H04B 10/30; H04B 10/08

(52) U.S. Cl. 398/38; 398/115; 398/9

(57) ABSTRACT

Several systems and method for remotely monitoring a communication system are disclosed. An RF signal received at a remote facility is analyzed at the remote facility and an ancillary data signal including information relation to at least one characteristic of the RF signal is generated. The ancillary data signal is modulated and combined with the RF signal. The combined RF signal is transmitted to a local facility in an optical form, where the ancillary data signal is recovered. An ancillary data signal block provides control signal in response to the local ancillary data signal. The control signals may be local control signals for controlling local devices or remote control signals for controlling devices at the remote facility. The ancillary data may include a power level of the RF signal and a version of the RF signal may be generated at the local facility with a power level approximately equal to the power level of the original RF signal.

### FIELD

This invention relates to radio frequency (RF) communication systems. More particularly, it relates to systems and method of remotely monitoring communication equipment and signals.

### BACKGROUND

In many communication systems, signals are received at a location or facility remote from a control or monitoring facility. For example, a communication system may include an antenna that is located on the roof of a building or at geographically remote location or at another location or facility that is not typically staffed by engineers or other communication systems personnel. Signals received at the remote location or facility are transmitted to a local signal processing or signal monitoring facility. In many systems this transmission is performed using an optical transmission line, either due to the distance separating the remote and local facilities or due to the availability of the optical line or for another reason. In other systems, the transmission may be performed using a wireless or wired RF communication line.

At the signal monitoring facility, the radio frequency signal is typically processed and may be retransmitted or reproduced. For example, a radio frequency signal may be filtered, demodulated and otherwise processed and then reproduced. When the RF signal is received at the local facility, it may appear to have errors in it. For example, the signal may have bit errors (if the signal is digital), have missing sections, a low carrier to noise ratio, a low power level or other signal deficiencies or errors. The equipment or personnel at the local facility may not be able to determine what the cause of the signal error is. For example, an error may be introduced into the signal before it is received at the remote facility. Alternatively, an error may be introduced into the signal after it is received at the remote facility, during processing at the remote facility, transmission to the local facility or in the processing equipment at the local facility.

Several systems have been developed to monitor an RF signal at a remote facility and to transmit information about the RF signal to the local facility. Such information about an RF signal may be referred to ancillary data relating to the signal. However, these RF signal monitoring systems typically require that the ancillary data be transmitted on a separate communication line from the primary RF signal, often referred to as a backhaul link or channel.

In some cases, the remote facility or local facility are connected by an optical data transmission line over which the RF signal received at the remote facility is transmitted to the local facility. Some system provide for transmission of both the RF signal and the ancillary data over the optical line. The RF signal is converted into an optical signal. The ancillary data signal is also converted into an optical signal. The two signals are combined using optical wavelength division multiplexed and are transmitted on the optical line. At the local facility, the two signals are separated using an optical demultiplexer and are separately converted back into electrical signals and further processed. The techniques require the use of expensive wave length division multiplexing and de-multiplexing equipment at the remote and local facilities.

There is a need for a more efficient and cost effective system for transmitting ancillary data relating to an RF signal from a remote site to a local site.

### SUMMARY

In one aspect the present invention provides a system for remotely monitoring an RF communication system comprising: a remote module including: a RF signal reception terminal for receiving an original RF signal; a signal analysis module coupled to the RF signal reception terminal to provide an ancillary data signal corresponding to at least one characteristic of the RF signal; a modulator coupled to the signal analysis module for providing a modulated ancillary data signal corresponding to the ancillary data signal; a combiner coupled to the RF signal reception terminal for receiving the original RF signal and coupled to the modulator for receiving the modulated ancillary data signal, wherein the combiner is adapted to provide a combined RF signal corresponding to the original RF signal and the modulated ancillary data signal; an RF to optical converter for converting the combined RF signal into a combined optical signal; a communication line coupled to the combiner for transmitting the combined optical signal.

Some embodiments of the system includes a local module that includes an optical to RF converter coupled to the communication line for converting the combined optical signal and providing a local combined RF signal; and demodulator coupled to optical to RF converter for receiving the combined RF signal and for demodulating the modulated ancillary data signal to provide a local ancillary data signal.

In some embodiments, the local module further includes an ancillary data signal filter coupled between the communication line and the demodulator to filter the combined RF signal and to provide the modulated ancillary data signal to the demodulator.

In some embodiments, the local module further includes a combined RF signal splitter coupled to the communication line to receive the combined RF signal and to provide a first copy of the combined RF signal to the ancillary data filter.

In some embodiments, the local module further includes an ancillary data processing block coupled to the demodulator to receive the local ancillary data signal and to provide at least one local control signal.

In some embodiments, the local module further includes an ancillary data processing block coupled to the demodulator to receive the local ancillary data signal and to provide at least one local data signal.

In some embodiments, the local module further includes an ancillary data processing block coupled to the demodulator to receive the local ancillary data signal and to provide at least one remote control signal.

In some embodiments, the local module further includes an ancillary data processing block coupled to the demodulator to receive the local ancillary data signal and to provide at least one remote control signal.

In some embodiments, the local module further includes: a programmable gain stage coupled to the combined RF signal splitter to receive a second copy of combined RF signal and to amplify the second copy of the combined RF signal to provide an amplified RF signal; and an local RF signal power monitor coupled to the programmable gain stage to receive the amplified RF signal and to provide a local RF signal power level to the ancillary data processing block, wherein the ancillary data processing block is coupled to the programmable gain stage to control the power of the amplified RF signal.

In some embodiments, the local ancillary data processing block is configured to control the power of the amplified RF signal in response to the local ancillary data signal.

In some embodiments, the local ancillary data signal includes a power level of the original RF signal and the ancillary data processing block is configured to vary the power of the amplified RF signal in response to the power level of the original RF signal.

In some embodiments, the local ancillary data signal includes a power level of the original RF signal and the ancillary data processing block is configured to vary the power of the amplified RF signal to be approximately equal to the power level of the original RF signal.

In some embodiments, the local module includes a power level terminal for receiving a local power level signal and the ancillary data processing block is configured to vary the power of the amplified RF signal in response to the local power level signal.

In some embodiments, the local module includes a power level terminal for receiving a local power level signal and wherein the local ancillary data signal includes a power level of the original RF signal and the ancillary data processing block is configured to vary the power of the amplified RF signal in response to the local power level signal and the power level of the original RF signal.

In some embodiments, the system further includes a combined RF signal filter coupled between to the combined RF signal splitter to receive a second copy of the combined RF signal and to provide a filtered RF signal in which the modulated ancillary gain signal is suppressed and wherein the filtered RF signal corresponds to the original RF signal.

Another aspect of the invention provides a method of remotely monitoring a communication system comprising: receiving an original RF signal at a remote facility; generating an ancillary data signal corresponding to at least one characteristic of the original RF signal; modulated the ancillary data signal to provide a modulated ancillary data signal; combining the modulated ancillary data signal with the local original signal with the original RF signal or a version of the original RF signal to provide a combined RF signal; converting the combined RF signal into a combined optical signal; transmitting the combined optical signal from the remote facility to a local facility on an optical transmission line; receiving the combined optical signal at the local facility; recovering a local ancillary data signal corresponding to at least one characteristic of the original RF signal; generating one or more control signals in response to the local ancillary data signal.

In some embodiments, the local ancillary data signal is recovered by converting the combined optical signal into a local combined RF signal, splitting the local combined RF signal to provide a first copy of the locate combined RF signal and filtering the first copy of the local combined RF signal to provide the local ancillary data signal.

In some embodiments, the ancillary data signal also corresponds to one characteristic of the remote facility.

In some embodiments, the ancillary data signal also corresponds to one characteristic of communication equipment installed at the remote facility.

In some embodiments, the ancillary data signal includes ancillary data relating to the power level of the original RF signal.

In some embodiments, the method further includes filtering the modulated ancillary data signal from a second copy of the local combined RF signal to provide a local RF signal.

In some embodiments, the method further includes applying a gain to the local RF signal to provide an amplified RF signal, measuring the power level of the amplified RF signal; varying the gain applied to the local RF signal in response to the power level of the amplified RF signal and the power level of the original RF signal.

In some embodiments, the gain is applied to the local RF signal such that the power level of the amplified RF signal is approximately equal to the power level of the original RF signal.

In some embodiments, the method further includes receiving a gain offset, wherein the gain is applied to the local RF signal such that the power level of the amplified RF signal differs from the power level of the original RF signal in response to the gain offset.

In some embodiments, the method further includes receiving a power level signal, wherein the gain is applied to the local RF signal such that the power level of the amplified RF signal corresponds to the power level signal.

Additional aspects of the invention are identified below in the description of several exemplary embodiments of the invention.

### BRIEF DESCRIPTION OF THE DRAWINGS

A preferred embodiment of the present invention will now be described in detail with reference to the drawings, in which:

FIG. 1 illustrates a first monitoring system 100;

FIG. 2 illustrates the various frequencies various possible ancillary data signal frequencies; and

FIG. 2 illustrates a second monitoring system 200.

### DETAILED DESCRIPTION OF EXEMPLARY EMBODIMENTS

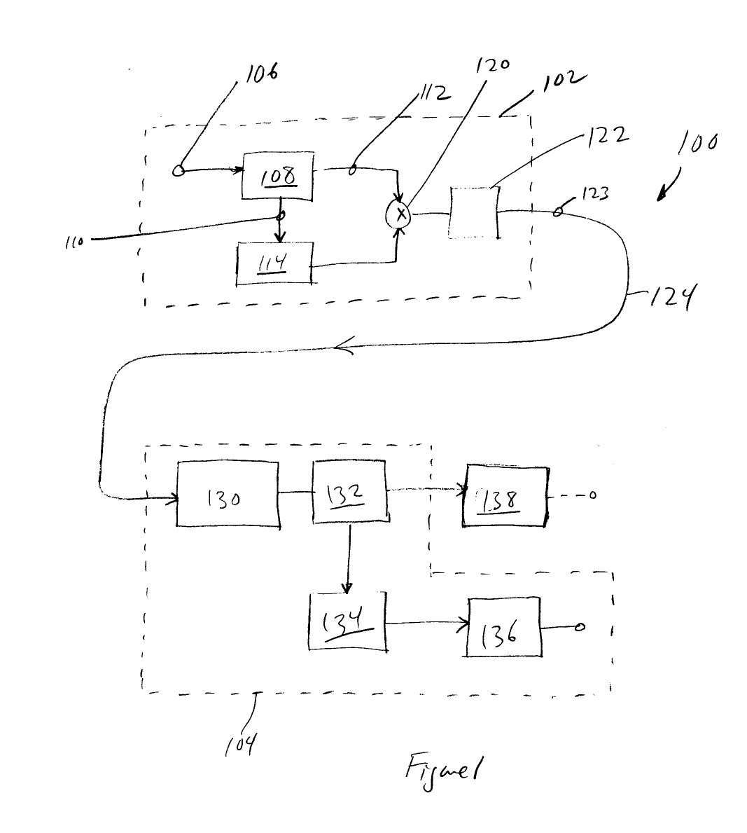

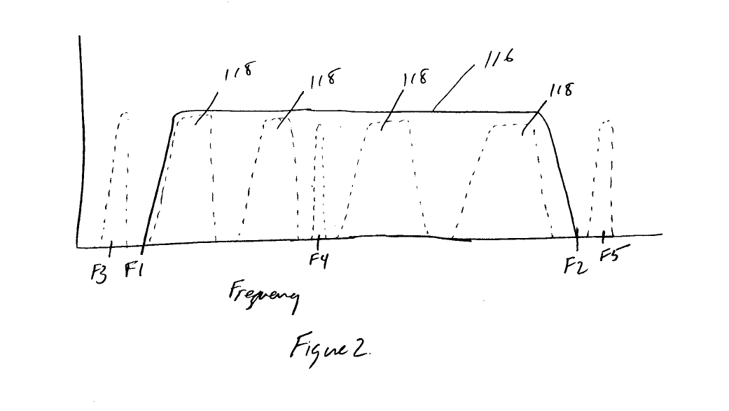

Reference is first made to FIG. 1, which illustrates a system 100 having a remote module 102 and a local module 104. The remote module 102 is typically installed at a remote location or facility. The local module 104 is typically installed or accessible from a local location or facility.

At the remote module 102, an RF signal is received at an RF reception terminal 106. This RF signal is also referred to herein as the original RF signal. The RF signal reception terminal 106 may be coupled to any type of RF signal source such as a satellite dish or any other type of RF signal processing equipment. An analysis module 108, which monitors and analyze the RF signal, is coupled to the RF signal reception terminal 106. The analysis module 108 includes a signal analyzer which analyzes the RF signal and generates an ancillary data signal containing ancillary data relating to one or more characteristics of the RF signal. The ancillary data for example might relate to the signal strength of the RF signal, the frequency band of the RF signal, the carrier to noise ratio of the RF signal or the presence of interference or other unwanted RF signals within the frequency range of the RF signal. The RF signal monitor has an ancillary data terminal 110 and a RF signal output terminal 112. The original RF signal received from the RF signal reception terminal 106, or a version of the original RF signal, is coupled through to the RF signal output signal 112 (or is at least reproduced at the RF signal output terminal 112). An ancillary data modulator 114 is coupled to the ancillary data terminal 110.

Optionally, in some embodiments, the ancillary data may include data relating to equipment installed at the remote location or facility, including the remote module 102, such as the operating status or configuration settings of any such equipment. The ancillary data may also include data relating to other characteristics of the remote location, such as environmental conditions at the remote location.

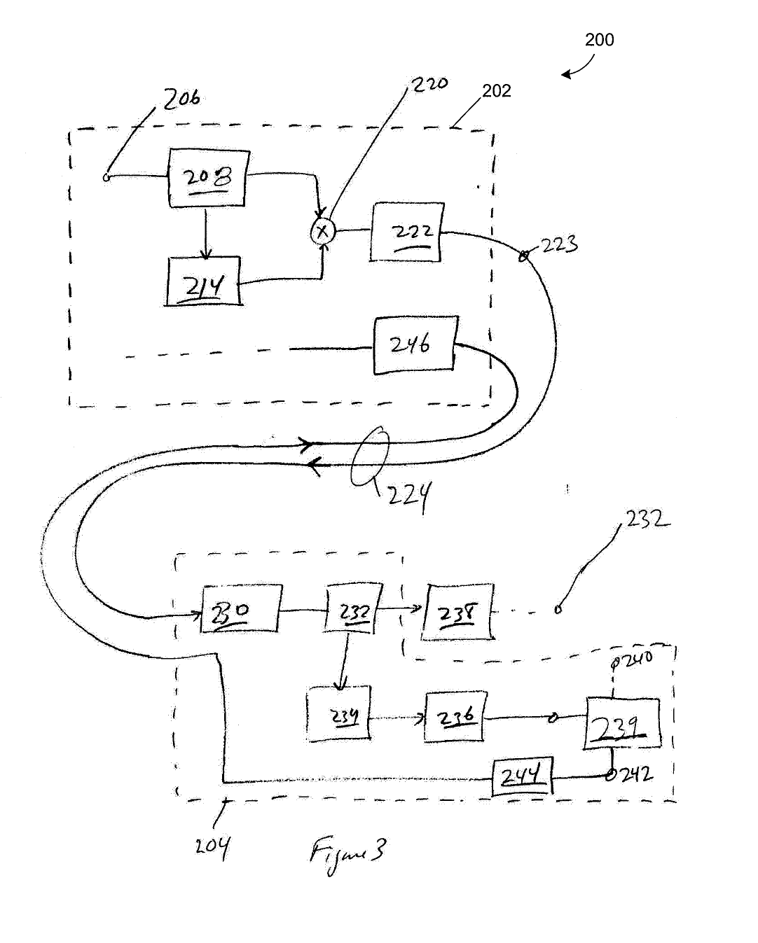

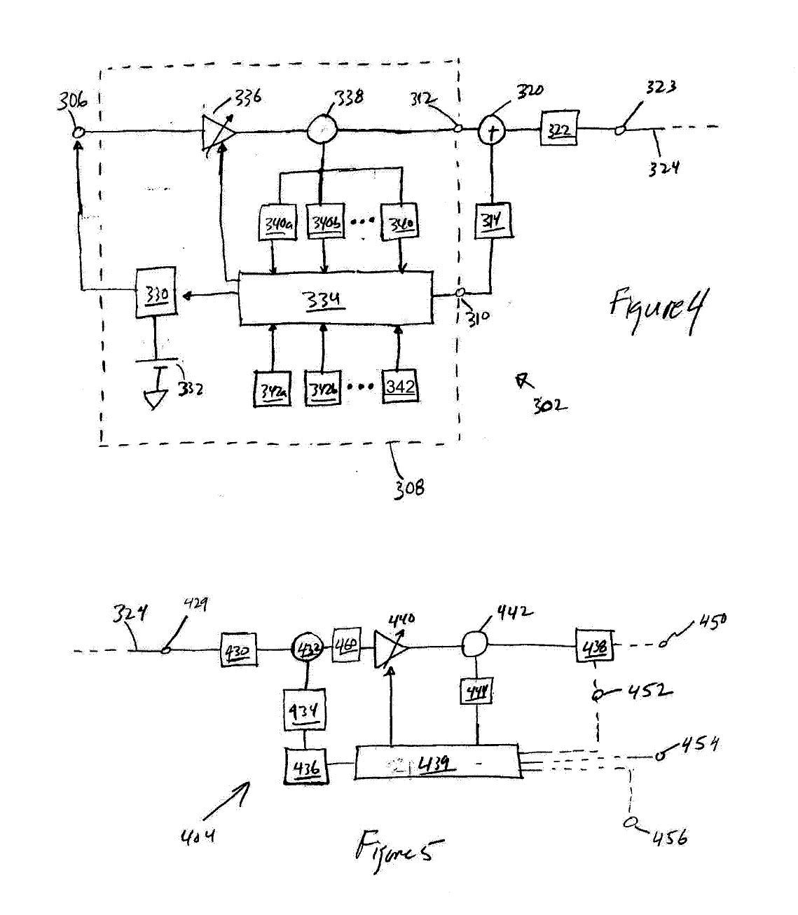

Reference is briefly made to FIG. 2, which illustrates a typical RF signal 116 having a pass band between frequency F1 and frequency F2. Within the RF signal, a number of frequency beams 118 are used by various signal components, for example, the frequency bands 118 may be used by individual channels within the broader RF signal between the frequency bands 118 there is typically some unused bandwidth. For example, the frequency range at and near frequency F4 is unused in this example. The ancillary data modulator modulates the ancillary data signal to a frequency that is not used by the desired frequency components 118 of the RF signal. The modulation frequency is referred to here as the ancillary data frequency. The ancillary data frequency may be a frequency that is unused within the pass band of the RF signal 116 or it may be a frequency that is below the pass band, for example frequency F3. Alternatively, the ancillary data frequency may be a frequency that is higher than the pass band of the RF signal, for example frequency F5. The ancillary data modulator 114 produces a modulated ancillary data signal at the ancillary data terminal 110.

Referring again to FIG. 1, a mixer or combiner 120 receives the original RF signal, or a version of the original RF signal, from terminal 112 and the modulated ancillary data signal from the ancillary data terminal and combines the two signals to produce a combined RF signal. The combined RF signal is converted into a corresponding optical signal by a RF to optical signal converter 122. Optical signal converter 122 produces a combined optical signal at optical output terminal 123. The combined optical signal corresponds to the RF signal received at the RF signal reception terminal 106 and to the modulated ancillary data signal.

An optical transmission line 124 is coupled to the RF optical signal converter 122 and transmits the combined optical signal from the remote module 102 to the local module 104. At the local module 104, the combined optical signal is received by an optical to the electrical signal converter 130 that converts the combined optical signal into a local combined RF signal. An RF signal splitter 132 receives the local combined RF signal and provides two copies of the local RF signal. An ancillary data signal filter receives one copy of the local combined RF signal from the RF signal splitter 132 and filters it at the ancillary data signal frequency to provide a local modulated ancillary data signal. The ancillary data signal filter 134 may be a band pass filter that is configured to extract a frequency band around the ancillary data signal frequency F4 thereby providing a local modulated ancillary data signal.

In other embodiments, where the ancillary data signal frequency is below or above the bandpass of the original RF signal, the ancillary data signal filter 134 may be a low pass filter or high pass filter.

A demodulator 136 is coupled to the ancillary data filter 134 and demodulates the local modulated ancillary signal to reproduce a local ancillary data signal which corresponds to the original ancillary data signal produced by the analysis module 108.

By providing the ancillary data signal in the electrical domain at analysis module 108 and combining the modulated ancillary data signal with the RF signal at combiner 120, the combined RF signal can then be converted into the optical domain and transmitted from the remote facility to the local facility in an optical transmission line 124. This eliminates the need for an independent back-haul channel to transmit the insulated data signal in a transmission path that is separate from the optical path in which the RF signal is typically transmitted from the remote facility to the local facility. This also eliminates the need for wave length division multiplexing in the optical domain.

The ancillary data frequency is selected such that the optical transmission line 124 and all other components in the remote module 102 and local module 104 in which the ancillary data signal is processed or transmitted are operable at the ancillary data frequency.

Referring briefly again to FIG. 1, the other RF signal produced by RF signal splitter 132 may be used by RF signal processing equipment 138 at the local facility which processes the RF signal. For example, the RF signal processing equipment may include a demodulator and any processing equipment that allows for reproduction or other processing or analysis of the original RF signal.

The RF signal demodulator 136 will typically be coupled to an ancillary data analysis device or system that displays the ancillary data system or components of it to a user and which may optionally use the ancillary data to control other components at the local facility.

Reference is next made to FIG. 3 that illustrates a second system 200. Components of system 200 that correspond to components of system 100 are identified by similar reference numerals. System 200 includes an ancillary data processing block 239 that uses the local ancillary data signal reproduced by demodulator 236 to control the operation of devices at the local and remote facilities. Ancillary data processed in block 239 is configured to analyze the characteristics that are reported within the ancillary data signal and generates local control signals at a local control terminal 240 and remote control signals at a remote control terminal 242. The local control signals may report information from the ancillary data signal for example the carrier to noise ratio or unacceptable levels of interference, missing channels or other data errors. Such errors may be displayed on a monitor to a user of system 200 and may also be used to control local equipment at the local facility. Similarly, the remote control signals may be used to control equipment at the remote facility. For example, the local control signal may be coupled to the RF signal processing equipment for use in processing the RF signal.

The remote control signals are generated as electrical signals and are converted into the optical domain by an electrical to optical converter 244 to produce the optical control signals. The optical control signals are coupled into the transmission line 224 which operates bidirectionally to transmit the optical control signals to a remote control device 246. Remote control device 246 at the remote facility is coupled to the devices within the remote control facility to control the operation of such devices. For example, the remote control device may activate redundant equipment in the event of an equipment failure, or may activate noise cancellation equipment in the event that the carrier to noise ratio of an RF signal is to low, may modify the orientation of an antenna or satellite dish to switch between transmitter or satellites.

In other embodiments, the remote control signals may be transmitted independent of communication line 224. For example, the remote control signals may be transmitted from the local module to the remote module on a separate optical communication line or through a separate wired or wireless communication link. For example, the remote control signals may be transmitted through the Internet or another IP based network.

In systems 100 and 200, an optical communication line couples the remote module 102, 202 and the local module 104, 204. In other embodiments, another type of communication line such as a wired or wireless communication line may be used. For example, a co-axial cable, Ethernet or other wired communication link may be used. Similarly, a wireless communication link may be used. The remote module and the local module may be coupled through a network that includes several different communication lines and links, and may include any combination of wired, wireless and optical or other communication links.

Reference is next made to FIG. 4, which illustrates an example remote module 302 in greater detail. Components of remote module 302 that correspond to components of remote module 102 are identified with similar reference numerals. Remote module 302 has an RF reception terminal 306, an analysis module 308, a modulator 314, a combiner 320, and an RF to optical signal converter 322.

An RF signal is received at RF signal reception terminal 306. As noted above, the RF signal reception terminal may receive the RF signal from various types of signal sources including a satellite dish or other signal reception device or from a signal generation device. In some cases, it is desirable to provide power to the signal source. For example, it may be desirable to power a Low Noise Block (LNB) or Low Noise Amplifier (LNA) antenna in a satellite dish. Remote module 302 includes an optional power inserter 330. Power inserter injects a DC power signal onto the RF signal reception terminal. This power signal can be used to power an LNB, LNA or other components of the signal source. Power inserter 330 receives power from a power source 332.

Analysis module 308 includes a controller 334 that controls the operation of the remote module 302. Optionally, as is illustrated in FIG. 4, controller 334 may be coupled to power inserter 330 to control the power injected into the RF signal reception terminal 302. Analysis module 308 also includes a programmable gain stage 336, an RF signal splitter 338, one or more RF signal analyzers 340 and, optionally, one or more remote facility sensors 342.

The RF signal received at the RF signal reception terminal 306 is coupled to gain stage 336. Gain stage 336 operates under the control of controller 334 to amplify the power (by a factor of less than, equal to or greater than 1) of the RF signal and provides an amplified RF signal. Splitter 338 receives the amplified RF signal and splits it into two signal, coupling the amplified RF signal to both the RF signal output terminal 312 and to one or more RF signal analyzers 340.

A particular embodiment of a remote module may have various RF signal analyzers. Remote module 302 includes an RF signal power monitor 340a and a tuner 340b. Other RF signal analyzers in other remote modules may includes demodulators, spectrum analyzers or any other device that may be used to analyze an RF signal.

Each of the RF signal analyzers provides an analyzer data signal to the controller 334. Controller 334 uses the analyzer data signals to generate an ancillary data signal at ancillary data terminal 310. The ancillary data signal may simply include the data provided by the RF signal analyzers or it may additionally or alternatively include results of additional processing of that data performed in the controller 334. Controller 334 may be configured to provide such data or results in the ancillary data signal.

Optionally, a remote module may also include one or more remote facility sensors 342. Each remote facility sensor 342 is adapted to monitor one or more characteristic of a device, environmental condition or other aspect of the remote facility. For example, a remote facility sensor 342 may be adapted to provide:
monitor the temperature, humidity or other environmental condition at the remote facility;
monitor the temperature or other operational condition of any component of the RF signal source, such as an LNB or LNA, the remote module, or any other device or component at the remote facility;
provide a video or audio signal from a camera or microphone at the remote facility; or
any other condition at the remote facility.

Each of the remote facility sensors provides a sensor data signal to the controller 334. Controller 334 uses the sensor data signal to generate the ancillary data signal.

The controller 334 may include some or all of the data in the analyzer and sensor data signals in the ancillary data signal, and may include data generated from the analyzer and sensor data signals in the ancillary data signal. For example, the power monitor 340a may provide a power level signal that corresponds to the power level of the RF signal across some or all of the spectrum of the RF signal. The controller 334 may include the power level in the ancillary data signal on an ongoing basis. As another example, one of the remote facility sensors may be an ambient temperature sensor 342a, which provides a period ambient temperature signal. The controller 334 may monitor the ambient temperature signal, but may be configured to include the ambient temperature data in the ancillary data signal if the ambient temperature is higher than a threshold. In another embodiment, the controller may simply include a digital “over-temperature” indication in the ancillary data signal if such a trouble condition arises. Such an over-temperature signal is derived from the ambient temperature signal received from the ambient temperature sensor 342a.

The ancillary data signal is modulated by the modulator 314 to provide a modulated ancillary data signal corresponding to the ancillary data signal. The modulator may modulate the ancillary data signal at a frequency that is higher, within or below the pass band of the RF signal received at the RF signal reception terminal 306. The modulator may use any modulation technique to modulate the ancillary data signal, such as phase modulation, frequency modulation, amplitude modulation, frequency shift keying, phase shift keying, amplitude shift keying, quadrature amplitude modulation, polar modulation, continuous phase modulation, minimum-shift keying, Gaussian minimum-shift keying, orthogonal frequency division multiplexing, wavelet modulation, trellis coded modulation, any form of digital baseband modulation or line coding, any form of pulse modulation or any other form of analog of digital modulation.

Combiner 320 combines the amplified RF signal at RF signal output terminal 312 and the modulated ancillary data signal from the modulator 314 to produce a combined RF signal. The combined RF signal is converted into a combined optical signal by the RF to optical signal converter 322 at an optical signal output terminal 323. The combined optical signal is transmitted on the optical transmission line 324.

Reference is next made to FIG. 5, which illustrates an exemplary local module 404. Components of local module 404 that correspond to components of local modules 104 and 204 are identified with corresponding reference numerals.

Local module 404 has a combined optical signal input terminal 429 to which an optical transmission line may be coupled. For the purpose of the present exemplary description, optical transmission line 324 is assumed to be coupled to the combined optical signal input terminal 429.

An optical to electrical signal converter 430 is coupled to the combined optical signal input terminal 429 to receive the combined optical signal which provides a local combined RF signal corresponding to the combined RF signal generated by combiner 320. A splitter 432 is coupled to the converter 430 and splits the local combined RF signal into two corresponding local combined RF signals. An ancillary data signal filter 434 filters is coupled to the splitter 432 and is adapted to filter the local combined RF signal to provide a local modulated ancillary data signal that corresponds to the modulated ancillary data signal generated by the modulator 314. A demodulator 436 is coupled to the filter 434 to receive the modulated ancillary data signal demodulates the modulated ancillary data signal to provide a local ancillary data signal corresponding to the ancillary data signal produced by the controller 334 in the remote module 302. The local ancillary data signal is provided to a local controller 439.

An optional filter 460 is configured to splitter 432 and is adapted to filter out the modulated ancillary data signal from local combined RF signal. A programmable amplifier 440 is coupled to the filter 460 (or where the filter 460 is not provided, to the splitter 432) and is programmable under the control of the local controller 439 to amplify or attenuate the local combined RF signal.

In remote module 302 and local module 404, the modulation frequency for the modulate ancillary data signal is selected to be lower than the pass band of the original RF signal received at the RF signal reception terminal 106. The filter 460 is a high pass filter with a cut-off frequency below the pass band of the original RF signal, but higher than the modulation frequency. In other embodiments, the filter 460 may be a band stop (or notch) filter or a low pass filter if the modulation frequency is chosen to be within or above the pass band of the original RF frequency.

A splitter 442 provides the amplified RF signal to RF signal processing equipment 438, which may include any type of RF signal demodulation or processing equipment to permit the RF signal to be used at a local facility or at any other facility.

A power monitor 444 receives the amplified RF signal from the splitter 442 and provides an RF signal power level signal to the controller 439 corresponding to the power in the full spectrum or part of the spectrum of the RF signal.

Controller 439 receives the ancillary data signal from the demodulator 436 and the power level signal from the power monitor 444 generates a gain control signal that is coupled to the amplifier 440. In this embodiment, the ancillary data signal includes the power level of the original RF signal. The controller generates the gain signal so that the RF signal coupled by the splitter to the RF signal processing equipment 438 has approximately the same power as the original RF signal, effectively providing substantially the same RF signal to the RF signal processing equipment as was received at the RF signal reception terminal 306.

In other embodiments, the controller may generate the gain control signal to provide an RF signal with a higher or lower power level than the original RF signal. In some embodiments, the power may be controllable and the controller may receive a power level signal at a power level terminal (not shown) indicating a desired power level, which may be in the form of a power to be added or removed relative to the original RF signal (i.e. a gain offset) or an absolute power level.

The controller also optionally generates local control signals at a terminal 452 that is coupled to the RF signal processing equipment. The gain signal provided to the amplifier 440 is an example of a local control signal. The local control signal may be used by the RF signal processing equipment to process the RF signal. The controller may also optionally generate local data signal at a terminal 454 which may be coupled to display equipment to display status information about the original RF signal or about the remote facility or equipment at the remote facility. The controller may also optionally generate remote control signals, which may be coupled to the remote facility as described above in relation to system 200.

The present invention has been described here by way of example only. Various modification and variations may be made to these exemplary embodiments without departing from the spirit and scope of the invention.

1. A system for remotely monitoring an RF communication system comprising:
a remote module including:
a RF signal reception terminal for receiving an original RF signal;
a signal analysis module coupled to the RF signal reception terminal to provide an ancillary data signal corresponding to at least one characteristic of the RF signal;
a modulator coupled to the signal analysis module for providing a modulated ancillary data signal corresponding to the ancillary data signal;
a combiner coupled to the RF signal reception terminal for receiving the original RF signal and coupled to the modulator for receiving the modulated ancillary data signal, wherein the combiner is adapted to provide a combined RF signal corresponding to the original RF signal and the modulated ancillary data signal;
an RF to optical converter for converting the combined RF signal into a combined optical signal;
a communication line coupled to the combiner for transmitting the combined optical signal.

2. The system of claim 1 further including:
a local module including:
an optical to RF converter coupled to the communication line for converting the combined optical signal and providing a local combined RF signal; and
a demodulator coupled to the optical to RF converter for receiving the combined RF signal and for demodulating the modulated ancillary data signal to provide a local ancillary data signal.

3. The system of claim 2 wherein the local module further includes an ancillary data signal filter coupled between the communication line and the demodulator to filter the combined RF signal and to provide the modulated ancillary data signal to the demodulator.

4. The system of claim 3 wherein the local module further includes a combined RF signal splitter coupled to the communication line to receive the combined RF signal and to provide a first copy of the combined RF signal to the ancillary data signal filter.

5. The system of claim 2 wherein the local module further includes an ancillary data processing block coupled to the demodulator to receive the local ancillary data signal and to provide at least one local control signal.

6. The system of claim 2 wherein the local module further includes an ancillary data processing block coupled to the demodulator to receive the local ancillary data signal and to provide at least one local data signal.

7. The system of claim 5 wherein the local module further includes an ancillary data processing block coupled to the demodulator to receive the local ancillary data signal and to provide at least one remote control signal.

8. The system of claim 2 wherein the local module further includes an ancillary data processing block coupled to the demodulator to receive the local ancillary data signal and to provide at least one remote control signal.

9. The system of claim 4 wherein the local module further includes:
a programmable gain stage coupled to the combined RF signal splitter to receive a second copy of combined RF signal and to amplify the second copy of the combined RF signal to provide an amplified RF signal;
an local RF signal power monitor coupled to the programmable gain stage to receive the amplified RF signal and to provide a local RF signal power level to the ancillary data processing block,
wherein the ancillary data processing block is coupled to the programmable gain stage to control the power of the amplified RF signal.

10. The system of claim 9 wherein the ancillary data processing block is configured to control the power of the amplified RF signal in response to the local ancillary data signal.

11. The system of claim 10 wherein the local ancillary data signal includes a power level of the original RF signal and the ancillary data processing block is configured to vary the power of the amplified RF signal in response to the power level of the original RF signal.

12. The system of claim 10 wherein the local ancillary data signal includes a power level of the original RF signal and the ancillary data processing block is configured to vary the power of the amplified RF signal to be approximately equal to the power level of the original RF signal.

13. The system of claim 10 wherein the local module includes a power level terminal for receiving a local power level signal and the ancillary data processing block is configured to vary the power of the amplified RF signal in response to the local power level signal.

14. The system of claim 10 wherein the local module includes a power level terminal for receiving a local power level signal and wherein the local ancillary data signal includes a power level of the original RF signal and the ancillary data processing block is configured to vary the power of the amplified RF signal in response to the local power level signal and the power level of the original RF signal.

15. The system of claim 4 further including a combined RF signal filter coupled between the combined RF signal splitter to receive a second copy of the combined RF signal and to provide a filtered RF signal in which the modulated ancillary gain signal is suppressed and wherein the filtered RF signal corresponds to the original RF signal.

16. A method of remotely monitoring a communication system comprising:
receiving an original RF signal at a remote facility;
generating an ancillary data signal corresponding to at least one characteristic of the original RF signal;
modulating the ancillary data signal to provide a modulated ancillary data signal;
combining the modulated ancillary data signal with the local original signal with the original RF signal or a version of the original RF signal to provide a combined RF signal;
converting the combined RF signal into a combined optical signal;
transmitting the combined optical signal from the remote facility to a local facility on an optical transmission line;
receiving the combined optical signal at the local facility;
recovering a local ancillary data signal corresponding to at least one characteristic of the original RF signal.

17. The method of claim 38 wherein generating the control signal includes generating at least one remote control signal adapted to control equipment at the remote facility and transmitting the remote control signal to the remote facility.

18. The method of claim 17 wherein the remote control signal is transmitted on the optical transmission line.

19. The method of claim 17 wherein the remote control signal is transmitted to the remote facility on a communication link other than the optical transmission line.

20. The method of claim 16 wherein the local ancillary data signal is recovered by converting the combined optical signal into a local combined RF signal, splitting the local combined RF signal to provide a first copy of the local combined RF signal and filtering the first copy of the local combined RF signal to provide the local ancillary data signal.

21. The method of claim 16 wherein the ancillary data signal also corresponds to one characteristic of the remote facility.

22. The method of claim 16 wherein the ancillary data signal also corresponds to one characteristic of communication equipment installed at the remote facility.

23. The method of claim 16 wherein the ancillary data signal includes ancillary data relating to the power level of the original RF signal.

24. The method of claim 23 further comprising,
filtering the modulated ancillary data signal from a second copy of the local combined RF signal to provide a local RF signal.

25. The method of claim 24 wherein at least one of the control signals is a local control signal adapted to be used for processing the local RF signal.

26. The method of claim 24 further comprising:
applying a gain to the local RF signal to provide an amplified RF signal,
measuring the power level of the amplified RF signal;
varying the gain applied to the local RF signal in response to the power level of the amplified RF signal and the power level of the original RF signal.

27. The method of claim 26 wherein the gain is applied to the local RF signal such that the power level of the amplified RF signal is approximately equal to the power level of the original RF signal.

28. The method of claim 26 further including receiving a gain offset, wherein the gain is applied to the local RF signal such that the power level of the amplified RF signal differs from the power level of the original RF signal in response to the gain offset.

29. The method of claim 26 further including receiving a power level signal, wherein the gain is applied to the local RF signal such that the power level of the amplified RF signal corresponds to the power level signal.

30. The system of claim 1, wherein the remote module further includes a power inserter for injecting a DC power signal onto the RF signal reception terminal, and a controller coupled to the power inserter for controlling the injecting of the DC power signal.

31. The system of claim 1, wherein the RF signal reception terminal is coupled to a programmable gain stage for amplifying an original RF signal and providing an amplified RF signal.

32. The system of claim 31, wherein the remote module further includes
a RF signal splitter coupled to the programmable gain stage for receiving the amplified RF signal and for providing a first copy of the amplified RF signal to a RF signal output terminal and a second copy of the amplified RF signal to one or more RF signal analyzers; and
a controller coupled to the one or more RF signal analyzers for providing the ancillary data signal, where the ancillary data signal includes at least analyzer data signals generated by the one or more RF signal analyzers.

33. The system of claim 1, wherein the remote module further includes
one or more facility sensors for monitoring characteristics of a remote facility; and
a controller coupled to the one or more facility sensors for providing the ancillary data signal, where the ancillary data signal includes at least sensor data signals generated by the one or more facility sensors.

34. The method of claim 16 further comprising:
injecting a DC power signal into a signal source of the original RF signal.

35. The method of claim 16, further comprising:
amplifying the original RF signal and providing an amplified RF signal.

36. The method of claim 35, further comprising:
receiving the amplified RF signal, splitting the amplified RF signal to provide a first and a second copy of the amplified RF signal; and
providing the ancillary data signal and including in the ancillary data signal at least analyzer data signals generated from the amplified RF signal.

37. The method of claim 16, further comprising:
monitoring characteristics of the remote facility; and
providing the ancillary data signal and including in the ancillary data signal at least sensor data signals generated from the monitored characteristics of the remote facility.

38. The method of claim 16, further comprising:
generating one or more control signals in response to the local ancillary data signal.
